(19) United States
(12) Patent Application Publication
(10) Pub. No.: US 2026/0221405 A1
(43) Pub. Date: Jul. 30, 2026

(54) NANO-ION PROBE FREEZING SAMPLE TABLE

(71) Applicant: Institute of Geology and Geophysics, Chinese Academy of Sciences, Beijing (CN)

(72) Inventors: Jialong HAO, Beijing (CN); Wei YANG, Beijing (CN); Sen HU, Beijing (CN); Hengci TIAN, Beijing (CN); Yangting LIN, Beijing (CN)

(21) Appl. No.: 19/170,705

(22) Filed: Apr. 4, 2025

(30) Foreign Application Priority Data
Jan. 26, 2025 (CN) 2025101216514

(51) Int. Cl. H01J 49/04

(52) U.S. Cl. CPC H01J 49/0468; H01J 49/0409

(57) ABSTRACT

The disclosure discloses a nano-ion probe frozen sample table in the field of nano-ion probes, including a frozen sample assembly including a frozen sample holder and a frozen sample rack arranged on one face of the frozen sample holder; a normal-temperature sample assembly including a normal-temperature sample holder and a normal-temperature sample rack arranged on one face of the normal-temperature sample holder; and a base platform, two sides of one face of the base platform are respectively connected to the frozen sample holder and the normal-temperature sample holder; another face of the base platform is connected to a sample table; the base platform is in an ion sputtering chamber, one side of the ion sputtering chamber is connected to a flange, the flange internally houses a refrigeration assembly. The refrigeration assembly transfers low temperature to the frozen sample holder to freeze the sample to a solid state.

### TECHNICAL FIELD

The disclosure relates to the field of nano-ion probes, and in particular to a nano-ion probe freezing sample table.

### BACKGROUND

Ion probe micro-area analysis exhibits significant advantages, including high spatial resolution, high analytical precision, high sensitivity, and low analytical background. As the ion probe technology with the highest spatial resolution currently available, nano-ionic probes have been widely applied in fields such as comparative planetology, earth sciences, materials science, and biomedicine. However, constrained by the analytical mechanism of secondary ion probes, current nano-ionic probe technology is limited to analyzing solid samples and cannot meet the demand for in-situ analysis of non-solid samples.

In practical research, the demand for analyzing non-solid samples, such as fluid inclusions in petroleum and mineral deposits, as well as in biomedical studies, is increasingly growing. In-situ analysis of these non-solid samples is of significant importance for studying their original state, composition, and distribution characteristics. However, traditional nano-ionic probes, due to the lack of effective cryogenic and insulation design, cannot meet the requirements for low-temperature and high-precision analysis of these special samples. Therefore, the development of a nano-ionic probe device capable of cryogenically freezing non-solid samples and meeting high-voltage insulation requirements has become a critical technological advancement.

### SUMMARY

In view of the shortcomings of existing technologies, the present disclosure provides a nano-ion probe freezing sample table, addressing the limitation in current nano-ionic probe technology that only allows for the analysis of solid samples and fails to meet the demand for in-situ analysis of non-solid samples.

In order to achieve the above objectives, the disclosure is realized by the following technical scheme: a nano-ion probe freezing sample table, including:
a frozen sample assembly including a frozen sample holder and a frozen sample rack, where the frozen sample rack is arranged on one face of the frozen sample holder;
a normal-temperature sample assembly including a normal-temperature sample holder and a normal-temperature sample rack, where the normal-temperature sample rack is arranged on one face of the normal-temperature sample holder;
a base platform, where two sides of one face of the base platform are respectively connected to the frozen sample holder and the normal-temperature sample holder; another face of the base platform is connected to a sample table; and the base platform is disposed within an ion sputtering chamber, one side of the ion sputtering chamber is connected to a flange, the flange internally houses a refrigeration assembly configured to cool the frozen sample assembly.

Optionally, the refrigeration assembly includes a liquid nitrogen cold trap, a heat conducting copper strip and a liquid nitrogen dewar, where the liquid nitrogen cold trap is installed in the flange; one end of the heat conducting copper strip is connected with a heat conducting block, and the other end is connected with an aluminum nitride ceramic block; the heat conducting block is connected with the liquid nitrogen cold trap; the aluminum nitride ceramic block is connected with the frozen sample holder; and the liquid nitrogen dewar is communicated with the flange.

Optionally, both the frozen sample holder and the frozen sample rack are made of red copper.

Optionally, the base platform is made of zirconia ceramics.

Optionally, a high-voltage bridge wire is arranged inside the sample table, and both ends of the high-voltage bridge wire pass through the base platform and are respectively connected with the frozen sample holder and the normal-temperature sample holder.

Optionally, a wire is installed on the outer wall of the ion sputtering chamber, and the wire is connected with the high-voltage bridge wire.

Optionally, motors are also installed on the outer wall of the ion sputtering chamber, and the motors are connected with the sample table through a transmission rod.

Optionally, the middle part of the flange plate is communicated with a bin-penetrating flange for pressurizing the ion sputtering chamber and reading the temperature of the sample in the ion sputtering chamber.

Optionally, one end of the ion sputtering chamber is communicated with a primary ion source chamber plate valve, and the other end is communicated with a secondary ion detection chamber plate valve.

Optionally, the sample table is movably arranged in the ion sputtering chamber, and primary ions enter the ion sputtering chamber from one side of the ion sputtering chamber far from the flange.

This disclosure provides a nano-ion probe freezing sample table, with the following beneficial effects:
First, the present disclosure efficiently transfers low-temperature conditions to the frozen sample holder through the action of the refrigeration assembly, enabling samples to be frozen into a solid state. As a result, the disclosure achieves high-precision in-situ analysis of liquid inclusions and biomedical tissue sections, particularly suitable for analytical procedures requiring maintenance of the sample's original state under cryogenic conditions.
Second, this disclosure employs beryllium copper for the frozen sample holder and support structure, thereby enabling highly efficient thermal conductivity. This material choice ensures uniform and stable temperature distribution across the frozen samples, maintaining their integrity throughout the analysis process. Moreover, the use of aluminum nitride ceramic blocks, which possess excellent thermal conductivity and electrical insulation properties, effectively isolates the high-voltage environment from the sample. This dual-material design not only guarantees the efficient transfer of low temperatures to the sample but also safeguards against potential electrical hazards, thereby ensuring the stability and safety of the entire analysis process.
Third, according to the disclosure, when not required for frozen sample analysis, the frozen sample holder can serve as a vacuum cold trap. The refrigeration assembly is capable of improving the vacuum performance of the ion sputtering chamber, thereby enhancing the working environment of the equipment. This multifunctional design enhances the instrument's practicality and cost-effectiveness, enabling adaptation to more diverse experimental requirements and meeting application scenarios across various fields.
Forth, according to the disclosure, the high-voltage bridge wiring enables application of −8000V potential through conductive leads when using a cesium ion source, and +8000V potential when using an oxygen ion source. This configuration ensures equipotential conditions between the frozen sample holder and normal-temperature sample holder, thereby preventing electric field distortion caused by potential differences.

### BRIEF DESCRIPTION OF THE DRAWINGS

FIG. 1 is a schematic diagram of the three-dimensional structure according to the present disclosure.

FIG. 2 is a schematic structural diagram of a normal temperature sample assembly according to the present disclosure.

FIG. 3 is a schematic structural diagram of a frozen sample assembly according to the present disclosure.

FIG. 4 is a schematic structural diagram of a high-voltage bridge wiring part according to the present disclosure.

In the figures: 1. ion sputtering chamber; 2. flange; 3. liquid nitrogen dewar; 4. liquid nitrogen cold trap; 5. frozen sample assembly; 51. frozen sample holder; 52. frozen sample rack; 6. normal-temperature sample assembly; 61. normal-temperature sample holder; 62. normal-temperature sample rack; 7. base platform; 8. sample table 8; 9. heat-conducting copper strip; 10. heat-conducting block; 11. aluminum nitride ceramic block; 12. wire; 13. high-voltage bridge wire; 14. motor; and 15. bin-penetrating flange.

### DETAILED DESCRIPTION OF THE EMBODIMENTS

The technical solutions in the embodiments of the present disclosure will be clearly and completely described below with reference to the accompanying drawings in the specification. It is apparent that the described embodiments represent only a portion of the embodiments of the present disclosure, rather than all possible implementations. All other embodiments obtained by persons of ordinary skill in the art based on the embodiments of the present disclosure without creative efforts shall fall within the protection scope of the present disclosure.

In order to better understand the present disclosure, the above content will be described in detail with reference to specific embodiments.

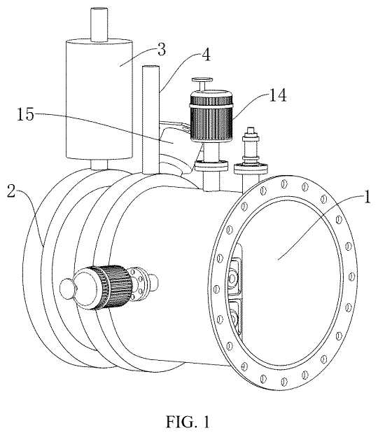

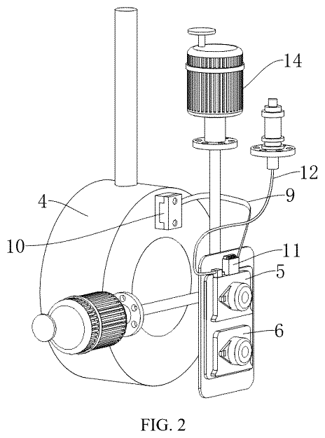

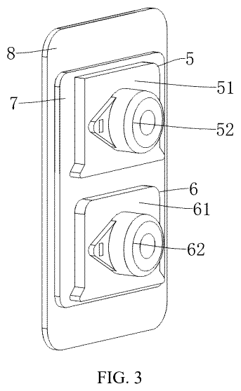

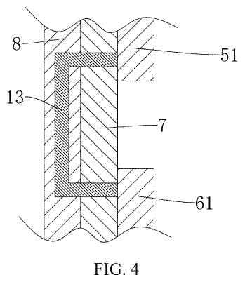

Embodiment 1: as shown in FIG. 1-FIG. 4, a nano-ion probe freezing sample table is provided, including:
a frozen sample assembly 5 including a frozen sample holder 51 and a frozen sample rack 52, where the frozen sample rack 52 is arranged on one face of the frozen sample holder 51;
a normal-temperature sample assembly 6 including a normal-temperature sample holder 61 and a normal-temperature sample rack 62, where the normal-temperature sample rack 62 is arranged on one face of the normal-temperature sample holder 61;
a base platform 7, where two sides of one face of the base platform 7 are respectively connected to the frozen sample holder 51 and the normal-temperature sample holder 61; another face of the base platform 7 is connected to a sample table 8; and the base platform 7 is disposed within an ion sputtering chamber 1, one side of the ion sputtering chamber 1 is connected to a flange 2, the flange 2 internally houses a refrigeration assembly configured to cool the frozen sample assembly 5.

Samples can be positioned using the frozen sample assembly 5 and the normal-temperature sample assembly 6. Specifically, the normal-temperature sample rack 62 can be securely fastened to the normal-temperature sample holder 61 via a clamp, ensuring that the samples remain stably fixed during the analysis process; and at the same time, the samples can be replaced after the normal-temperature sample rack 62 is removed. Similarly, the frozen sample rack 52 is fixed on the frozen sample holder 51 using a clamp, and the frozen samples can be replaced after the frozen sample rack 52 is removed; the base platform 7 and the sample table 8 can be used to support the frozen sample assembly 5 and the normal-temperature sample assembly 6. At the same time, the refrigeration assembly can transfer the low-temperature conditions to the frozen sample assembly 5. At this time, the samples in the frozen sample assembly 5 can be frozen into a solid state, so the analysis of liquid inclusions and biomedical tissue sections can be realized.

The refrigeration assembly includes a liquid nitrogen cold trap 4, a heat conducting copper strip 9 and a liquid nitrogen dewar 3, where the liquid nitrogen cold trap 4 is installed in the flange 2; one end of the heat conducting copper strip 9 is connected with a heat conducting block 10, and the other end is connected with an aluminum nitride ceramic block 11; the heat conducting block 10 is connected with the liquid nitrogen cold trap 4; the aluminum nitride ceramic block 11 is connected with the frozen sample holder 51; and the liquid nitrogen dewar 3 is communicated with the flange 2. Both the frozen sample holder 51 and the frozen sample rack 52 are made of red copper. The base platform 7 is made of zirconia ceramics.

The integration of the heat-conducting copper strip 9, the heat-conducting block 10, and the aluminum nitride ceramic block 11 effectively transfers low temperature to the frozen sample assembly 5, thereby freezing the sample and rendering it solid. The heat-conducting copper strip 9, the frozen sample holder 51, and the frozen sample rack 52 are made of red copper, which has an extremely high thermal conductivity of up to 400 W/(m·K). This allows for rapid and efficient transfer of low temperatures, ensuring uniform temperature distribution within the frozen sample assembly 5. Additionally, red copper is not only highly conductive to heat but also to electricity, enabling effective current transmission and preventing resistance issues in high-voltage environments, thus enhancing the stability of the device. The thermal conductivity of the aluminum nitride ceramic block 11 is exceptionally high among ceramic materials, with a thermal conductivity ranging from 170 to 200 W/(m·K), which is 6 to 10 times higher than that of ordinary alumina ceramics. This enables it to efficiently transfer the freezing temperature; moreover, unlike red copper, aluminum nitride ceramic possesses excellent insulating properties, with a resistivity as high as 1012 Ω·cm. It can effectively isolate electric current under high-voltage conditions, ensuring the safety of the frozen sample holder 51 in high-voltage environments. Moreover, the thermal expansion coefficient of aluminum nitride ceramic is close to the thermal expansion coefficient of silicon, making it suitable for use in low-temperature environments. This property helps avoid stress cracking or delamination caused by differences in thermal expansion coefficients. Additionally, aluminum nitride ceramic has good chemical stability, enabling it to resist corrosion from liquid nitrogen or other cooling media, thereby ensuring stability during long-term use.

A high-voltage bridge wire 13 is arranged inside the sample table 8, and both ends of the high-voltage bridge wire 13 pass through the base platform 7 and are respectively connected with the frozen sample holder 51 and the normal-temperature sample holder 61. A wire 12 is installed on the outer wall of the ion sputtering chamber 1, and the wire 12 is connected with the high-voltage bridge wire 13.

When using a cesium ion source, a high voltage of −8000 V is applied; whereas when using an oxygen ion source, a high voltage of +8000 V is applied. The purpose of applying high voltage is to drive the cesium ion source or the oxygen ion source to generate a primary ion beam. The cesium ion source generates a negative ion beam through the application of high voltage, while the oxygen ion source generates a positive ion beam through the application of high voltage. The presence of high voltage enables the ion source to efficiently emit a high-energy primary ion beam toward the sample surface, providing the necessary energy for the sputtering process. Specifically, the primary ion beam strikes the sample surface with high energy, generating secondary ions through the sputtering effect. The signal intensity and stability of secondary ions are affected by the energy of the primary ion beam. By applying high voltage to the wire 12, the energy of the ion beam can be kept consistent, thereby enhancing the precision and reproducibility of the sputtering process.

Therefore, the high-voltage bridge wire 13 can maintain the same electrical potential for the frozen sample holder 51 and the normal-temperature sample holder 61, preventing the impact on sputtering efficiency and secondary ion detection due to uneven charge distribution on the sample surface caused by potential differences; At the same time, it ensures a uniform electric field distribution across the entire sample table 8, reducing electric field distortions caused by the high-voltage environment, thereby improving the accuracy and reliability of the analysis.

Motors 14 are also installed on the outer wall of the ion sputtering chamber 1, and the motors 14 are connected with the sample table 8 through a transmission rod. A bin-penetrating flange 15 is communicated in the middle part of the flange plate 2 for pressurizing the ion sputtering chamber 1 and reading the temperature of the sample in the ion sputtering chamber 1. One end of the ion sputtering chamber 1 is communicated with a primary ion source chamber plate valve, and the other end is communicated with the secondary ion detection chamber plate valve. The sample table 8 is movably arranged in the ion sputtering chamber 1, and primary ions enter the ion sputtering chamber 1 from one side of the ion sputtering chamber 1 far from the flange 2.

In this embodiment, the transmission rod can be driven to run by driving the motor 14, and then the sample table 8 can be driven to move, and there are two motors, so that the sample table 8 and the sample can be driven to move in the directions of the X and Y axes, thereby enabling point-by-point bombardment on the sample; further, by applying pressure to the bin-penetrating flange 15, the interior of the ion sputtering chamber 1 can be pressurized. With a temperature measuring device installed inside the bin-penetrating flange 15, the temperature within the ion sputtering chamber 1 can be monitored, thus enabling the detection of the sample's temperature.

Working principle: when in use, the low temperature of liquid nitrogen is transferred to the heat-conducting block 10 through the liquid nitrogen dewar 3, and then transferred to the frozen sample holder 51 through the heat-conducting copper strip 9 and the aluminum nitride ceramic block 11, so as to freeze the sample in the frozen sample rack 52 and make it solid. Then the primary ions enter the ion sputtering chamber 1 from the side of the ion sputtering chamber 1 far away from the flange 2. At this moment, the motor 14 is activated to operate the transmission rod. As the transmission rod moves, it drives the sample table 8 to move, which in turn moves the frozen sample assembly 5 and the normal-temperature sample assembly 6, thereby enabling the sample to point-by-point bombardment. The sputtered secondary ions are detected by mass spectrometer to realize the in-situ analysis of non-solid samples, so as to achieve the analysis goal of high precision, high sensitivity and low background noise.

The synergistic cooperation of the heat-conducting block 10, heat-conducting copper strip 9, and aluminum nitride ceramic block 11 enables the freezing of fluid inclusions and biomedical sections. Once solidified, the samples can be subjected to ion-source bombardment for analysis. By means of the wire 12, the high-voltage bridge wire 13 is supplied with power to ensure that the frozen sample holder 51 and the normal-temperature sample holder 61 have the same electrical potential. When using a cesium ion source, a high voltage of −8000 V is applied; when using an oxygen ion source, a high voltage of +8000 V is applied. This ensures the stability and consistency of the high-voltage environment for different types of ion sources, thereby guaranteeing the accuracy and reliability of the analysis results;

Embodiment 2: when there is no need to analyze the frozen sample, the frozen sample assembly 5 can be used as a vacuum cold trap. The specific operation is as follows: the ordinary normal-temperature sample is positioned on the normal-temperature sample rack 62. The liquid nitrogen cold trap 4 is then activated to enhance the vacuum performance of the ion sputtering chamber 1. During this process, the refrigeration assembly continues to operate, but it does not freeze the sample. It serves exclusively as a vacuum cold trap to improve the vacuum performance of the instrument;

Embodiment 3: for different types of non-solid samples, the designs of the frozen sample rack 52 and the frozen sample holder 51 can be adjusted according to the characteristics of the samples:
Liquid inclusion: a high-pressure sealed frozen sample rack 52 is used to prevent the sample from leaking during freezing.
Biomedical sliced samples: a specially designed frozen sample rack 52 is employed to ensure that the sample maintains its biological activity and structural integrity during the freezing process. In biomedical research, high-sensitivity detection of biomedical section samples can be achieved through the use of the specially designed frozen sample rack 52 and frozen sample holder 51, thereby ensuring the biological activity and structural integrity of the samples.

Embodiment 4: to meet the diverse requirements of different samples, the frozen sample rack 52 and the frozen sample holder 51 can be replaced with various types to accommodate the analysis needs of more non-solid samples. In the study of petroleum and ore deposits, high-precision analysis of fluid inclusions can be achieved through the use of specially designed frozen sample racks 52 and frozen sample holders 51.

Although embodiments of the present disclosure have been shown and described, it will be understood by those skilled in the art that various changes, modifications, substitutions and variations can be made to these embodiments without departing from the principles and spirit of the present disclosure, the scope of which is defined by the appended claims and their equivalents.

What is claimed is:

1. A nano-ion probe freezing sample table, comprising:
a frozen sample assembly (5) comprising a frozen sample holder (51) and a frozen sample rack (52), wherein the frozen sample rack (52) is arranged on one face of the frozen sample holder (51);
a normal-temperature sample assembly (6) comprising a normal-temperature sample holder (61) and a normal-temperature sample rack (62), wherein the normal-temperature sample rack (62) is arranged on one face of the normal-temperature sample holder (61);
a base platform (7), wherein two sides of one face of the base platform (7) are respectively connected to the frozen sample holder (51) and the normal-temperature sample holder (61); another face of the base platform (7) is connected to a sample table (8); and the base platform (7) is disposed within an ion sputtering chamber (1), one side of the ion sputtering chamber (1) is connected to a flange (2), the flange (2) internally houses a refrigeration assembly configured to cool the frozen sample assembly (5).

2. The nano-ion probe freezing sample table according to claim 1, wherein the refrigeration assembly comprises a liquid nitrogen cold trap (4), a heat conducting copper strip (9) and a liquid nitrogen dewar (3), wherein the liquid nitrogen cold trap (4) is installed in the flange (2); one end of the heat conducting copper strip (9) is connected with a heat conducting block (10), and the other end is connected with an aluminum nitride ceramic block (11); the heat conducting block (10) is connected with the liquid nitrogen cold trap (4); the aluminum nitride ceramic block (11) is connected with the frozen sample holder (51); and the liquid nitrogen dewar (3) is communicated with the flange (2).

3. The nano-ion probe freezing sample table according to claim 1, wherein both the frozen sample holder (51) and the frozen sample rack (52) are made of red copper.

4. The nano-ion probe freezing sample table according to claim 1, wherein the base platform (7) is made of zirconia ceramics.

5. The nano-ion probe freezing sample table according to claim 1, wherein a high-voltage bridge wire (13) is arranged inside the sample table (8), and both ends of the high-voltage bridge wire (13) pass through the base platform (7) and are respectively connected with the frozen sample holder (51) and the normal-temperature sample holder (61).

6. The nano-ion probe freezing sample table according to claim 1, wherein a wire (12) is installed on the outer wall of the ion sputtering chamber (1), and the wire (12) is connected with the high-voltage bridge wire (13).

7. The nano-ion probe freezing sample table according to claim 1, wherein motors (14) are also installed on the outer wall of the ion sputtering chamber (1), and the motors (14) are connected with the sample table (8) through a transmission rod.

8. The nano-ion probe freezing sample table according to claim 1, wherein a bin-penetrating flange (15) is communicated in the middle part of the flange plate (2) for pressurizing the ion sputtering chamber (1) and reading the temperature of the sample in the ion sputtering chamber (1).

9. The nano-ion probe freezing sample table according to claim 1, wherein one end of the ion sputtering chamber (1) is communicated with a primary ion source chamber plate valve, and the other end is communicated with the secondary ion detection chamber plate valve.

10. The nano-ion probe freezing sample table according to claim 1, wherein the sample table (8) is movably arranged in the ion sputtering chamber (1), and primary ions enter the ion sputtering chamber (1) from one side of the ion sputtering chamber (1) far from the flange (2).
